(19) United States
(12) Patent Application Publication
(10) Pub. No.: US 2016/0119055 A1
(43) Pub. Date: Apr. 28, 2016

(54) MEASUREMENT TRANSMISSION SYSTEM FOR HANDHELD METROLOGY TOOLS

(71) Applicant: Mitutoyo Corporation, Kanagawa-ken (JP)

(72) Inventor: Michael Nahum, Kirkland, WA (US)

(21) Appl. No.: 14/521,330

(22) Filed: Oct. 22, 2014

(51) Int. Cl. H04B 7/26

(52) U.S. Cl. CPC H04B 7/26

(57) ABSTRACT

A measurement transmission system is provided for being coupled to a handheld measuring device (e.g., a caliper, micrometer, etc.) for wirelessly transmitting measurement data to a remote system (e.g., a personal computer). An energy generation portion may be included that converts work done by a user (e.g., operating a button, slide, lever, etc.) into electrical energy for powering the wireless transmission. A data hold actuator may additionally or alternatively be included for freezing a set of measurement data to be used for subsequent wireless transmission (e.g., to preserve the accuracy of the measurement in case the caliper jaws are accidentally moved). In response to receiving the measurement data, the remote system may send a successful transmission signal back to the measurement transmission system (e.g., which may be used to trigger transmission cycle termination operations, data holding release operations, providing a notification to a user confirming the successful transmission, etc.).

### BACKGROUND

1. Technical Field

The invention relates to metrology systems, and more particularly to a measurement transmission system for wirelessly transmitting measurement data from a handheld measuring device to a remote system.

2. Description of the Related Art

Various handheld measuring devices are currently available. One example of such a handheld measuring device is a displacement measuring instrument, such as an electronic caliper which can be used for making precise measurements of physical dimensions of objects (e.g., measuring machined parts to ensure that they are meeting tolerance requirements). Exemplary electronic calipers are disclosed in commonly assigned U.S. Pat. Nos. RE37,490, 5,574,381, and 5,973,494, each of which is hereby incorporated by reference in its entirety.

It is obvious that the less power such calipers or other handheld measuring devices use, the fewer batteries (or other power sources) they will require and the longer they will operate before the batteries (or other power sources) need to be replaced or replenished. However, reducing the power requirements of such devices beyond current “micro watt” levels is a complex task. Such devices are required to make highly accurate measurements, and the complex signal processing techniques that have been developed for such devices tend to complicate the process of designing circuitry that will both accomplish the desired accuracy and operate at low voltage and power levels. In addition, in comparison to the basic operating and measuring requirements, certain functions (e.g., wireless transmission of measurement data) may require significant energy resources. In addition to the power requirements for such functions, the reliability or predictability of the measurements may be affected by various factors (e.g., accidental movement of the jaws of the caliper while the function is being performed). A need exists for improving the ability to perform functions such as the wireless transmission of measurement data in a manner that ensures that desirable measurement data is transmitted while minimizing the drain on the handheld measuring device's power source.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A measurement transmission system is provided for wirelessly transmitting measurement data from a handheld measuring device to a remote system. In various implementations, the handheld measuring device may be one of a caliper or micrometer, and the measurement data may be related to a physical dimension of a measured object. The measurement transmission system may include at least a device-side data connection portion, an output-side wireless transmission portion and a transmission activation portion. The device-side data connection portion may be configured to couple to the handheld measuring device and receive measurement data from the handheld measuring device. The output-side wireless transmission portion may be configured to wirelessly transmit measurement data to the remote system. The transmission activation portion may include a transmission actuator that may be operated manually by a user for triggering the measurement transmission system to perform operations including a transmission cycle of operations comprising wirelessly transmitting the measurement data to the remote system.

In various implementations, the measurement transmission system may include an energy generation portion that converts work done by a user (e.g., operating an energy generation actuator such as a button, slide, lever, etc.) into electrical energy for wirelessly transmitting the measurement data to the remote system. In one implementation, one transmission cycle of operations may consume a first amount of energy and the energy generation portion may be configured such that a single actuation cycle of the energy generation actuator generates a second amount of electrical energy that is greater than the first amount of energy. It will be appreciated that the wireless transmission of measurement data may otherwise utilize significant battery resources in handheld precision measuring devices, and that the utilization of a separate energy generation portion to power the wireless transmission may reduce such drains on the main battery.

In various implementations, the measurement transmission system may additionally or alternatively include a data hold actuator that may be operated manually by a user for triggering operations that initiate a data holding state that freezes a set of measurement data to be used for subsequent wireless transmission to the remote system. It will be appreciated that a data holding state may provide various advantages, such as allowing a user to temporarily save the measurement data and verify on a display that the measurement value is as expected (e.g., in case the caliper jaws are accidentally moved when the energy generation and/or transmission actuators or other elements are operated by the user).

In various implementations, once the measurement data is successfully received, the remote system may wirelessly transmit a successful transmission signal back to the measurement transmission system. In various implementations, once a successful transmission signal is received, or once the success of the transmission is otherwise determined, the measurement transmission system may perform various operations (e.g., performing transmission cycle termination operations to cease wireless transmission, performing data holding release operations to terminate a data holding state, providing a notification to a user on a display that indicates that the transmission was successful, etc.).

In various implementations, the measurement transmission system may be housed in a body portion to form a measurement transmission module which exposes at least one actuator (e.g., a transmission actuator, an energy generation actuator and/or a data hold actuator) to the user. In an alternative implementation, the measurement transmission system may be housed in the handheld measuring device. In various implementations, a single actuator (e.g., a button, slide, lever, etc.) may provide functions as a transmission actuator, an energy generation actuator and/or a data hold actuator. Alternatively, one or more additional actuators may be included for providing one or more of these functions.

### BRIEF DESCRIPTION OF THE DRAWINGS

FIG. 1 is a block diagram of a first exemplary embodiment of a measurement transmission system as coupled to a handheld measuring device and as wirelessly transmitting measurement data to a remote system;

FIGS. 2A and 2B are diagrams of a second exemplary embodiment of a measurement transmission system as coupled to a handheld measuring device for wirelessly transmitting measurement data to a remote system;

FIG. 3 is a diagram of a perspective view of a third exemplary embodiment of a measurement transmission system as coupled to a handheld measuring device;

FIG. 4 is a diagram of a perspective view of a fourth exemplary embodiment of a measurement transmission system as coupled to a handheld measuring device with a recessed portion for receiving the measurement transmission system;

FIG. 5 is a diagram of a front elevation view of a fifth exemplary embodiment of a measurement transmission system as housed in a handheld measuring device for wirelessly transmitting measurement data to a remote system; and

FIG. 6 is a block diagram illustrating an exemplary embodiment of circuit portions of a measurement transmission system, handheld measuring device and remote system.

### DETAILED DESCRIPTION

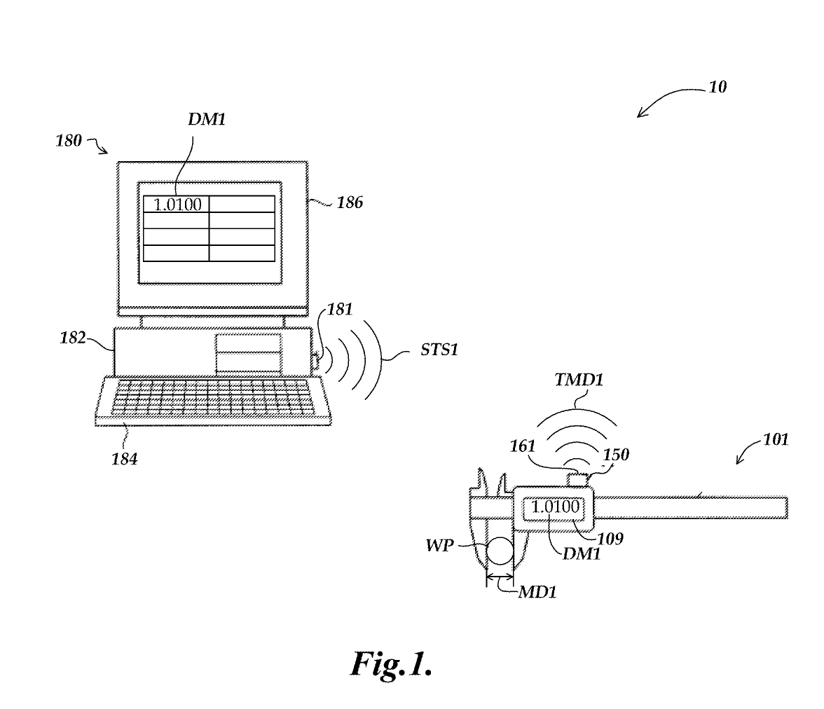

FIG. 1 is a block diagram of an exemplary measurement system 10 including a first exemplary embodiment of a measurement transmission system 150 as coupled to a handheld measuring device 101 and as wirelessly transmitting measurement data from the handheld measuring device 101 to a remote system 180. The transmitted measurement data TMD1 may be related to one or more measurements (e.g., a measured dimension MD1) of a workpiece WP taken with the handheld measuring device 101. The remote system 180 may include a computer system 182 that is operably connected to a keyboard 184 and a monitor 186 and/or other input or output devices. A representation of the measurement data from the handheld measuring device 101 may be displayed as a displayed measurement DM1 on a display 109 of the handheld measuring device 101 and/or on the monitor 186 of the remote system 180.

The measurement transmission system 150 may include an antenna 161 for wirelessly transmitting the measurement data and the remote system 180 may include an antenna 181 for receiving the transmitted measurement data TMD1. In various implementations, once the transmitted measurement data TMD1 is successfully received, the remote system 180 may utilize the antenna 181 to wirelessly transmit a successful transmission signal STS1, which may be received at the antenna 161 of the measurement transmission system 150. As will be described in more detail below, in various implementations once a successful transmission signal STS1 is received, or once a successful transmission is otherwise verified, the measurement transmission system 150 may perform various operations (e.g., performing transmission cycle termination operations to cease wireless transmission, performing data holding release operations to terminate a data holding state, providing a notification on a display that indicates that the transmission was successful, etc.).

As will also be described in more detail below, in various implementations the measurement transmission system 150 may include an energy generation portion that converts work done by a user (e.g., operating an energy generation actuator such as a button, slide, lever, etc.) into electrical energy for wirelessly transmitting the measurement data to the remote system 180. It will be appreciated that wireless transmission of data may otherwise utilize significant battery resources in handheld precision measuring devices, and that by powering the wireless transmission with a separate energy generation portion such significant drains on the main battery may be avoided. In various implementations, the measurement transmission system 180 may additionally or alternatively include a data hold actuator that may be operated manually by a user for triggering operations that initiate a data holding state that freezes a set of measurement data to be used for subsequent wireless transmission to the remote system 180. It will be appreciated that a data holding state may provide various advantages, such as allowing a user to temporarily save the measurement data and verify on a display (e.g., of the measurement transmission system and/or the display 109) that the measurement value is as expected (e.g., in case the caliper jaws are accidentally moved when the energy generation and/or transmission actuators or other elements are operated by the user).

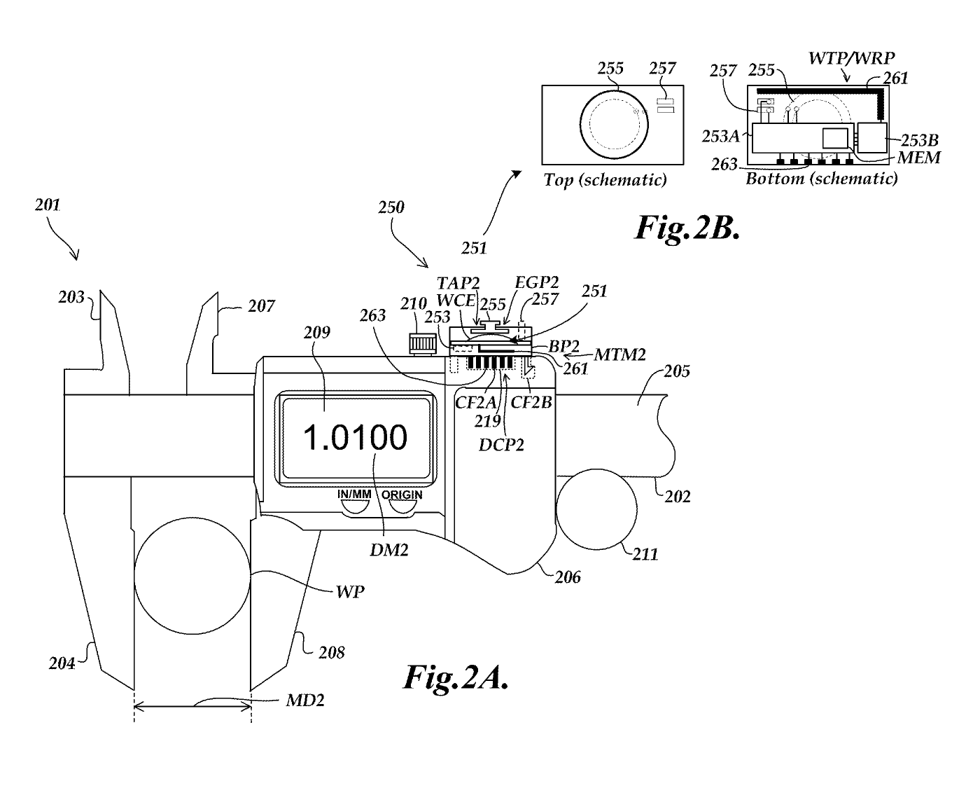

FIGS. 2A and 2B are diagrams of a second exemplary embodiment of a measurement transmission system 250 as coupled to a handheld measuring device 201 for wirelessly transmitting measurement data to a remote system (e.g., the remote system 180 of FIG. 1). It will be appreciated that the measurement transmission system 250 may have certain characteristics that are similar to those of the measurement transmission system 150 of FIG. 1, and will be understood to operate similarly except as otherwise described below. In the embodiment of FIG. 2A, the handheld measuring device 201 is a caliper capable of outputting measurement data obtained from measurement of a workpiece WP (e.g., corresponding to a measured dimension MD2 of the workpiece WP). The measurement transmission system 250 includes a first actuator 255 (e.g., a button), which in various implementations may provide functions as an energy generation actuator, a transmission actuator and/or a data hold actuator, as will be described in more detail below.

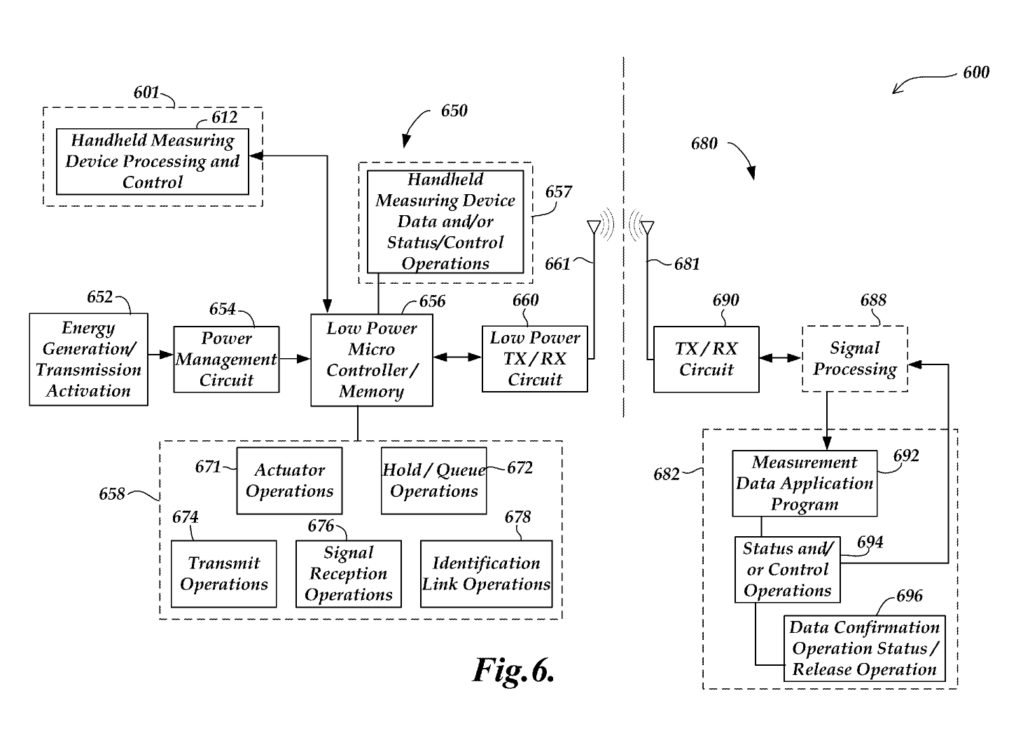

In various implementations, the first actuator 255 may be part of a transmission activation portion TAP2 and/or an energy generation portion EGP2. For example, as illustrated in FIG. 2B, a transmission activation portion TAP2 may be designated as including the first actuator 255 (e.g., designated as a transmission actuator), and portions of circuitry 253A and 253B on a circuit board assembly 251. An associated output-side wireless transmission portion WTP on the circuit board assembly 251 may be designated as including portions of circuitry 253B and an antenna 261. Examples of the circuitry 253A and 253B will be described in more detail below with respect to FIG. 6. For the operation of the transmission activation portion TAP2, switching functions in circuitry 253A may be activated by a user operating the first actuator 255 to trigger operations including a transmission cycle of operations which include utilizing circuitry 253B as coupled to the antenna 261 for wirelessly transmitting the measurement data to a remote system.

As further illustrated in FIGS. 2A and 2B, an energy generation portion EGP2 may be designated as including the first actuator 255 (e.g., designated as an energy generation actuator), a work conversion element WCE, and portions of circuitry 253A. For the operation of the energy generation portion EGP2, the first actuator 255 may be operated manually by a user, and is configured to perform work on the work conversion element WCE (e.g., a piezoelectric element such as a film or igniter, an electromagnetic generator, etc.). While the first actuator 255 is represented in FIG. 2A as a button, it will be appreciated that in other implementations alternative elements may be utilized (e.g., slides, levers, etc.), which may be utilized to perform work on corresponding work conversion elements. The work conversion element WCE converts the work into electrical energy that is utilized for powering at least the output-side wireless transmission portion WTP (e.g., including portions of circuitry 253B and the antenna 261) for wirelessly transmitting the measurement data to the remote system.

In one implementation, one transmission cycle of operations of the transmission activation portion TAP2 may consume a first amount of energy, and the energy generation portion EGP2 may be configured such that a single actuation cycle of the energy generation actuator 255 generates a second amount of electrical energy that is greater than the first amount of energy. In other words, in the implementation of FIG. 2, the overall operations of the measurement transmission system 250 may allow a user to press the actuator button 255 a single time to both trigger the wireless transmission of the measurement data and to generate enough electrical energy to power the wireless transmission.

In various implementations, the first actuator 255 may also or alternatively provide functions as a data hold actuator. In such implementations, the first actuator 255 may be operated manually by a user for triggering operations that initiate a data holding state that freezes a set of measurement data to be used for subsequent wireless transmission to the remote system. In one implementation, the handheld measuring device 201 may include a measurement display 209 and a hold mode of operation which includes freezing a current measurement value on the measurement display 209. In such an implementation, the operations that initiate a data holding state that freezes a set of measurement data may include triggering the hold mode of operation of the handheld measuring device 201 through a device-side data connection portion DCP2 (e.g., including a female connector 219), as will be described in more detail below. In an alternative implementation, the operations that initiate a data holding state that freezes a set of measurement data may include temporarily storing the set of measurement data in a memory MEM of the circuitry 253A of the measurement transmission system 250 for subsequent wireless transmission to the remote system.

In one implementation, the transmission cycle of operations may further include data holding release operations, which are performed subsequently to successfully transmitting the measurement data and which terminate the data holding state. For example, as described above with respect to FIG. 1, once the remote system 180 receives the wireless transmission of the measurement data, it may send a “successful transmission” signal STS1 back to the measurement transmission system 250. In such an instance, once the successful transmission signal STS1 is received, the measurement transmission system 150 may perform data holding release operations to terminate the data holding state. It will be appreciated that such functionality may provide a manner in which a user may be informed when the measurement data transmission has been successfully completed and that another measurement may be taken, in that the measurement indicated on the display 209 may remain frozen until the process is complete.

In one implementation, the transmission cycle of operations may further include transmission cycle termination operations, which are performed subsequently to successfully transmitting the measurement data and which terminate at least some operations of the measurement transmission system 250 until an actuator (e.g., actuator 255) of the measurement transmission system 250 is again operated manually by a user. Energy consumption and computational capacity may be conserved through such termination operations. The measurement transmission system 250 may also in addition to the wireless transmission portion WTP be designated as including a wireless receiver portion WRP (e.g., including the antenna 261 and portions of the circuitry 253B), wherein the transmission cycle termination operations may be performed subsequently to receiving a successful transmission signal STS1 from the remote system 180, as described above. The measurement transmission system may also or alternatively be enabled to provide an error message to a user if the transmission of the measurement data is not successful (e.g., if a successful transmission signal is not received from the remote system within a certain amount of time after the initiation of the wireless measurement data transmission).

In an implementation where the first actuator 255 provides multiple functions as a transmission actuator, an energy generation actuator and/or a data hold actuator, state-dependent operations may be utilized. For example, in one implementation state-dependent operations may indicate that a user will operate the actuator 255 (e.g., press the button 255) once to trigger operations that initiate the data holding state, and then operate the actuator 255 again to trigger the set of operations that includes the transmission cycle of operations and/or to generate energy for performing the data transmission. In such an implementation, the first press of the button 255 may freeze the measurement data (e.g., for which the user could verify the accuracy of the measurement on a display and further movement of components of the handheld measuring device 201 would not accidentally alter the measurement), after which the second press of the button 255 would wirelessly transmit the frozen/verified measurement data to the remote system 180. As described above, in one implementation a successful transmission signal STS1 received back from the remote system 180 may then trigger an unfreezing of the data holding state and/or a providing of an indication on a display that the transmission was successful. Thereafter, another measurement may be taken and transmitted, following the same procedure of starting with a first press of the button 255 to freeze the new measurement data, after which the second press of the button 255 may trigger the wireless transmission of the new measurement data.

In various implementations, a second actuator 257 may alternatively be provided for providing functions as the transmission actuator and/or the data hold actuator. For example, while the first actuator 255 with the associated work conversion element WCE may be utilized for converting work into electrical energy, the second actuator 257 as coupled to the circuitry 253A may be utilized in one implementation to perform a switching function to act as the transmission actuator and/or the data hold actuator. In an implementation where the second actuator 257 performs functions as the transmission actuator, in one configuration a user may first operate the first actuator 255 to generate electrical energy for powering the wireless transmission, and then may operate the second actuator 257 to trigger the wireless transmission of the measurement data. In an implementation where the second actuator 257 performs functions as the data hold actuator, in one configuration a user may first operate the second actuator 257 to freeze the measurement data, and then may operate the first actuator 255 to trigger the transmission cycle of operations and/or to generate energy for powering the wireless data transmission.

As will be described in more detail below, in various implementations the measurement transmission system 250 may include a transmission activation portion TAP2 and data hold functionality without an energy generation portion EGP2. For example, the measurement transmission system 250 may be made to include a separate battery and/or may be coupled to utilize electricity from a power supply of the handheld measuring device 201. In one such implementation, a single actuator may be utilized to provide the functions of the data hold actuator and the transmission actuator. For example, in one configuration a user may operate the actuator a first time to freeze the measurement data, and then may operate the actuator a second time to trigger the transmission cycle of operations, which are powered by a power source (e.g., a battery) of the handheld measuring device 201 or of the measurement transmission system 250. Alternatively, in one configuration a user may operate the actuator a single time to both freeze the measurement data and to trigger the transmission cycle of operations (e.g., for which the user could verify the accuracy of the measurement data that is being transmitted on a display, and for which the frozen state may be used to indicate that the transmission process has not yet been successfully completed, as described in the above examples).

In the example of FIGS. 2A and 2B, the measurement transmission system 250 is illustrated as being housed in a body portion BP2 which forms a measurement transmission module MTM2 which exposes at least the actuator 255 (e.g., a transmission actuator, an energy generation actuator and/or a data hold actuator) to the user. As will be described in more detail below, the measurement transmission module MTM2 may be configured to couple mechanically and/or electronically to at least one coupling feature (e.g., the data connection portion DCP2) on the handheld measuring device 201. The measurement transmission module MTM2 may in some instances not include a battery, and may be configured to operate without consuming power from the handheld measuring device 201 (e.g., relying instead on the energy generation portion EGP2 for providing any needed power). It will be appreciated that such a measurement transmission module MTM2 may be coupled to existing calipers (e.g., through an existing data port such as that of the data connection portion DCP2) and may add functionality for wireless measurement data transmission with data hold operations and/or energy generation for powering the wireless measurement data transmission. In an alternative implementation, a measurement transmission system may be housed in a handheld measuring device for providing such functionality, as will be described in more detail below with respect to FIG. 6.

In the example of FIG. 2, a coupling feature CF2A of the measurement transmission system 250 may include a device-side male connector 263 on a bottom portion, and an optional coupling feature CF2B may include an interlock portion that requires a specialized interlock release tool for removal. The device-side male connector 263 of the measurement transmission system 250 is received within the data connection portion DCP2 which includes the female connector 219 of the handheld measuring device 201. The female connector 219 may be part of the primary output port of the handheld measuring device 201 for providing measuring data to external devices (e.g., the remote system 180 of FIG. 1). In one implementation, the female connector 219 may include a sealing type elastomeric interconnector having alternating laminations of conductive portions and nonconductive portions, as described in more detail in commonly assigned U.S. Pat. No. 6,671,976, which is hereby incorporated by reference herein in its entirety. The male connector 263 may be a complementary type of connector. However, more generally, any suitable connection method may be used, and the female connector 219 may be part of an RS-232 port, a serial port, an interface such as a Digimatic interface compatible with a connector (e.g., a flat connector, a circular 6-pin connector, a flat 10-pin connector, etc.) or any other output port for providing measuring data to an external device. Certain types of output ports and connectors are described in more detail in commonly assigned U.S. Pat. No. 8,131,896, which is hereby incorporated by reference herein in its entirety. It will be appreciated that while such connectors are often utilized for providing wired connections between handheld measuring devices and external devices (e.g., the remote system 180 of FIG. 1), the connectors may alternatively be utilized as described herein for attaching a measurement transmission system to a handheld measuring device for wirelessly transmitting the measurement data to a remote system.

As shown in FIG. 2A, the handheld measuring device 201 has a main scale 202 having a longitudinal portion, and a slider 206 provided on the main scale 202 in a manner capable of sliding movement along the longitudinal direction of the main scale 202. The main scale 202 has an inside measurement jaw 203 and an outside measurement jaw 204 respectively provided on the upper and lower periphery on the base end of the longitudinal portion and a scale 205 provided at an inner portion of the longitudinal portion along the longitudinal direction. The inside measurement jaw 203 and the outside measurement jaw 204 are respectively integrated to the main scale 202.

The outer surface of the slider 206 is provided with an inside measurement jaw 207 and an outside measurement jaw 208 respectively formed on the upper and lower periphery on the base end and a digital display 209 formed on the front surface thereof. Further, a clamp screw 210 for fixing the position of the slider 206 is screwed thereto. A feed roller 211 to be in contact with the longitudinal portion of the main scale 202 to move the slider 206 by rotation thereof is provided on the outer surface of the slider 206.

During measurement operations, the slider 206 is moved by the feed roller 211 so that the measurement jaw 207 or 208 is in contact with a target portion of a workpiece WP together with the measurement jaw 203 or 204. At this time, the displacement of the slider 206 is detected by the scale 205 provided on the longitudinal portion of the main scale 202 and the detection head of the slider 206. The detected measurement signal which is represented as a measured dimension MD2 of the workpiece WP is processed as measurement data by a circuit board (not shown) to be displayed as a displayed measurement DM2 on the digital display 209 at the front side of the slider 206 and/or to be wirelessly transmitted by the measurement transmission system 250 to a remote system (e.g., the remote system 180 of FIG. 1), as described above.

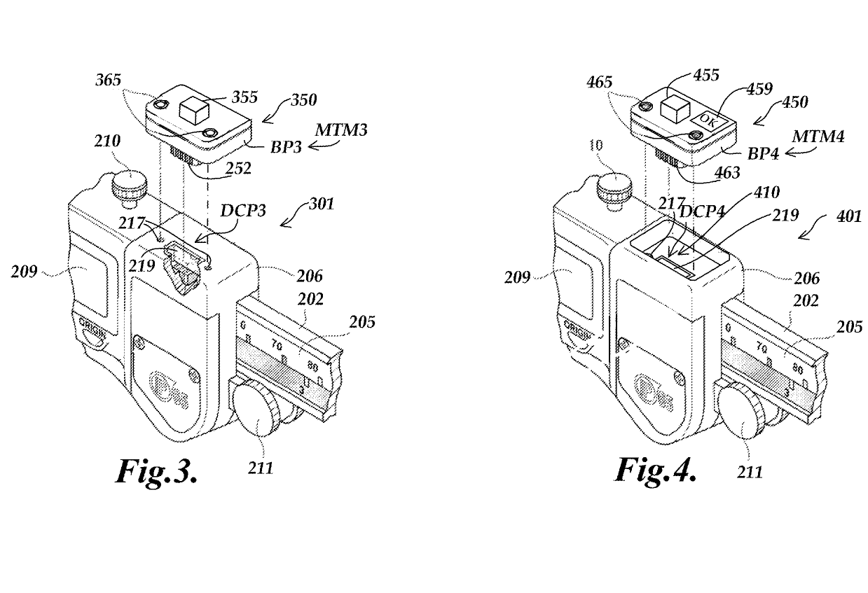

FIG. 3 is a diagram of a perspective view of a third exemplary embodiment of a measurement transmission system 350 as coupled to a handheld measuring device 301. It will be appreciated that the measurement transmission system 350 may have similar characteristics and will be understood to operate similarly to the measurement transmission systems 150 and 250, except as otherwise described below. As shown in FIG. 3, the measurement transmission system 350 includes an actuator 355, a device-side male connector 252, interlock fasteners 365, and a body portion BP3 as part of a measurement transmission module MTM3. The device-side male connector 252 is received within a female connector 219 of a data connection portion DCP3 of the handheld measuring device 301, similar to the connector 263 of FIG. 2. The handheld measuring device 301 includes holes 217 for receiving the interlock fasteners 365 of the measurement transmission system 350. In various implementations, the interlock fasteners 365 may consist of permanent, semi-permanent, or removable fasteners.

In various implementations, the actuator 355 may provide functions as an energy generation actuator, a transmission actuator and/or a data hold actuator, similar to the operations described above for the actuator 255 of FIG. 2. In the example of FIG. 3, only a single actuator 355 is provided as part of the measurement transmission system 350. Thus, in one implementation in which an energy generation portion is included in the measurement transmission system 350, a single operation of the actuator 355 (e.g., a press of the button 355) by a user may both trigger the transmission cycle of operations and generate energy for performing the wireless data transmission. In addition or alternatively, state-dependent operations may be utilized. For example, in one implementation where data holding operations are included in the measurement transmission system 350, state-dependent operations may include that a user will operate the actuator 355 once to trigger operations that initiate the data holding state, and then operate the actuator 355 again to trigger the set of operations that includes the transmission cycle of operations and/or to generate energy for performing the data transmission. In such an implementation, the first press of the button 355 may freeze the measurement data (e.g., for which the user could verify the accuracy of the frozen measurement on the display 209 of the handheld measuring device 201), after which the second press of the button 355 may wirelessly transmit the frozen/verified measurement data to the remote system 180. In various implementations, the display 209 may be utilized to provide an indication to the user of when a successful transmission signal is received from the remote system 180 or when the transmission is otherwise determined to have been successful. For example, as described above, in one implementation the indication may include an unfreezing of the measurement on the display 209, or other indications may also be provided on the display 209 (e.g., an “OK” symbol may be provided, etc.).

FIG. 4 is a diagram of a perspective view of a fourth exemplary embodiment of a measurement transmission system 450 as coupled to a handheld measuring device 401 with a recessed portion for receiving the measurement transmission system 450. It will be appreciated that the measurement transmission system 450 may have similar characteristics and will be understood to operate similarly to the measurement transmission systems 150, 250 and 350, except as otherwise described below. The measurement transmission system 450 (including an actuator 455) and handheld measuring device 401 are shown to be substantially similar to the measurement transmission system 350 and a handheld measuring device 301 of FIG. 3, with the primary differences being a recessed portion 410 of the measuring device 401 and a display 459 of the measurement transmission system 450.

As shown in FIG. 4, the recessed portion 410 is generally shaped so as to correspond to the outer body dimensions of a body portion BP4 of a measurement transmission module MTM4 which includes the measurement transmission system 450. The bottom of the recessed portion 410 includes a female connector 219 of a data connection portion DCP4 for receiving the device-side male connector 463 of the measurement transmission system 450. The recessed portion 410 also includes holes 217 for receiving interlock fasteners 465 of the measurement transmission system 450.

In one implementation, the recessed portion 410 has dimensions such that when the measurement transmission system 450 is secured within the recessed portion 410 by the interlock fasteners 465, the body portion BP4 of the measurement transmission system 450 is relatively flush with and does not significantly protrude from the surface of the handheld measuring device 401. When a new handheld measuring device 401 includes such a recessed portion 410, then it is convenient that the measurement transmission system 450 may be fit to it as an integrated portion, without disturbing the ideal ergonomics of the handheld measuring device 401. Alternatively, the measurement transmission system 450 may be left off to reduce the cost, and purchased and added at a later time if desired. Furthermore, an older model of a handheld measuring device (e.g., the handheld measuring device 301 of FIG. 3) that lacks the recessed portion 410 may still use the same measurement transmission system 450, which allows the economic benefits associated with fewer models and less inventory requirements for the measurement transmission system 450, and/or the handheld measuring devices 301 and/or 401.

In various implementations, the display 459 may be utilized to provide various types of information to a user regarding the operations of the measurement transmission system 450. For example, rather than utilizing the display 209 of the measuring device 201, the display 459 may alternatively provide an indication to the user of when a successful transmission signal is received from the remote system 180 or when the transmission is otherwise determined to have been successful. For example, as illustrated in FIG. 4, an “OK” symbol may be provided on the display 459 once a transmission has been determined to have been successful. In other implementations, a larger display may also be utilized (e.g., for displaying a frozen measurement data value, etc.). It will be appreciated that similar types displays may also be included with any of the previously described measurement transmission systems 150, 250 or 350.

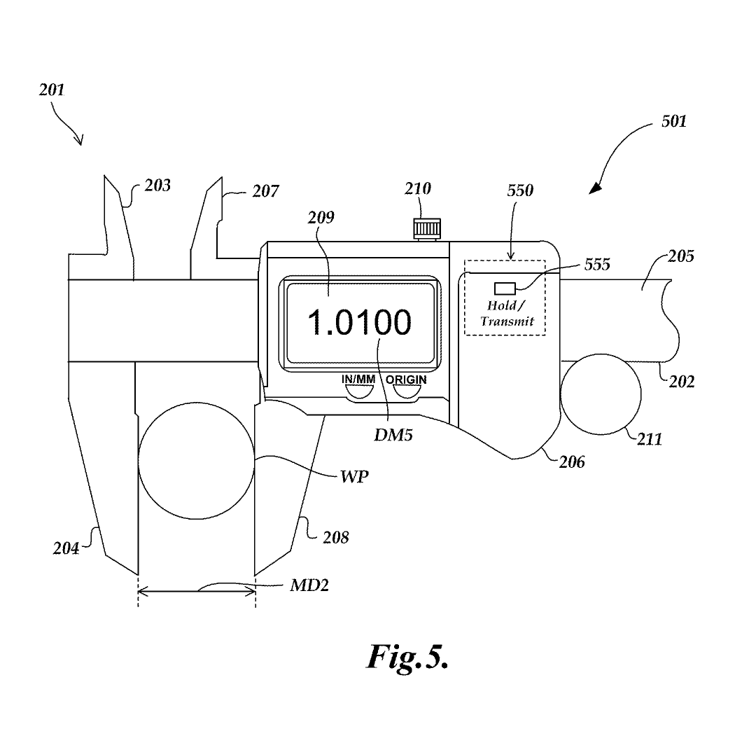

FIG. 5 is a diagram of a front elevation view of a fifth exemplary embodiment of a measurement transmission system 550 as housed in a handheld measuring device 501 for wirelessly transmitting measurement data to a remote system. It will be appreciated that the measurement transmission system 550 may have similar characteristics and will be understood to operate similarly to the measurement transmission systems 150, 250, 350 and 450 except as otherwise described below. In contrast to the measurement transmission systems 250, 350 and 450 which include body portions BP as part of removable and portable measurement transmission modules MTM, the measurement transmission system 550 is shown as integrated as part of and housed in the handheld measuring device 501 (e.g., is generally not intended to be removable and attachable to other measuring devices as part of normal operations).

In the example of FIG. 5, the measurement transmission system 550 is illustrated as including a single actuator 555 (e.g., shown as a “hold/transmit” button 555). Thus, similar to and as was described above with respect to FIG. 3, in various implementations state-dependent operations may be utilized with respect to the single actuator 555. For example, in one implementation state-dependent operations may function such that a user will operate the actuator 555 once to trigger operations that initiate the data holding state, and then operate the actuator 555 again to trigger the set of operations that includes the transmission cycle of operations and/or to generate energy for performing the data transmission. In operation, similar to the implementation of FIG. 2 as described above, a measured dimension MD2 of a workpiece WP is processed as measurement data to be displayed as a displayed measurement DM5 on the digital display 209 and/or to be wirelessly transmitted by the measurement transmission system 550 to a remote system (e.g., the remote system 180 of FIG. 1).

Due to the integration of the measurement transmission system 550 in the handheld measuring device 501, in one implementation a power source (e.g., a battery) of the measuring device 501 may be utilized to provide some or all of the energy required for the measurement data transmission. Alternatively, in one implementation an energy generation portion may still be included in the measurement transmission system 550 for providing the energy for the wireless transmission, so as to avoid draining the main battery of the measuring device 501 when the wireless transmission is activated. In various implementations, due to the integration of the measurement transmission system, the main display 209 and memory of the measuring device 501 may generally be utilized for any data hold operations (e.g., storing and displaying the frozen measurement data, as well as providing any indications to a user when the measurement data transmission has been successfully completed). In an alternative implementation, separate indicators may be provided on a separate display or otherwise on the outer surface of the measurement transmission system 550.

FIG. 6 is a block diagram illustrating an exemplary embodiment of a measurement system 600 including circuit portions for a measurement transmission system 650, handheld measuring device 601 and remote system 680. It will be appreciated that in various implementations, any or all of the circuit portions of FIG. 6 may be representative of circuit portions of the components of FIGS. 1-5. As shown in FIG. 6, the remote system 680 includes a computer system 682, a signal processing portion 688, a transmitter/receiver circuit 690 and an antenna 681. The computer system 682 includes a measurement data application program 692, status and/or control operations 694 and a data confirmation operation status/release operation 696. In various implementations, the computer system 682 may consist of a type of personal computing device, such as a PC, tablet, smart phone, etc. As described above with respect to FIGS. 1-5, the antenna 681 of the remote system 680 may receive and transmit signals from and to the measurement transmission system 650. For example, the remote system 680 may receive transmitted measurement data, and may transmit a “successful transmission” signal back to the measurement transmission system 650 once the measurement data has been successfully received. As part of the transmitting and receiving operations, the transmitter/receiver circuit 690 may utilize various existing technologies (e.g., a wireless USB transmission unit utilizing a wireless protocol such as Bluetooth, other types of wireless protocol transmitters/receivers, etc.).

In various implementations, the signal processing portion 688 may optionally be included, and may provide various formatting or other functions for converting the raw signals received by the receiver circuit 690 into a format for being processed by the measurement data application program 692. As one example, a protocol may be utilized to convert the raw measurement data that is received into measurement values that may be processed by the measurement data application program 692 (e.g., for being inserted in a spreadsheet, etc.). In one implementation, the signal processing component 688 may remove or otherwise process extraneous information (e.g., header information) from the signals received by the receiver circuit 690 (e.g., in particular for extraneous information that is not applicable or needed by the measurement data application program 692). As an alternative to the inclusion of a separate signal processing portion 688, the measurement data application program 692 may be configured to directly process the raw measurement data, identification, etc., signals that are received by the receiver circuit 690.

In various implementations, the measurement data application program 692 may be designated to be utilized with one or more specific handheld measuring devices 601 by a manufacturer, vendor, etc. In one implementation, the measurement data application program 692 may include a statistical process control program for receiving measurement data from a handheld measuring device 601, and may include a spreadsheet or other program into which the measurement values represented by the measurement data may be input.

The status and/or control operations 694 may determine and/or otherwise receive signals from the measurement data application program 692 which indicate the status of the processing of recently received measurement data. The data confirmation operation status/release operation 696 may utilize the determined status and indicate when a confirmation and/or release signal should be sent by the status and/or control operations 694 to the signal processing portion 688 for being transmitted back to the measurement transmission system 650. For example, as described above, in one implementation once the transmitted measurement data has been successfully received, the remote system 680 may send a successful transmission signal back to the measurement transmission system 650.

As also illustrated in FIG. 6, the measurement transmission system 650 includes an energy generation/transmission activation portion 652, a power management circuit 654, a low power micro control/memory 656, a handheld measuring device data and/or status/control operations portion 657, a controller routines portion 658, a low power transmitter/receiver circuit 660 and an antenna 661. In various implementations, various circuit components of the measurement transmission system 650 may correspond to certain components of the measurement transmission systems 150, 250, 350, 450 and/or 550, as described above. For example, in one implementation, the energy generation/transmission activation portion 652 may correspond to the transmission activation portion TAP2 and the energy generation portion EGP2 of FIGS. 2A and 2B. In addition, the circuit components 654-658 may correspond to the circuit portion 253A, while the low power transmitter/receiver circuit 660 may correspond to the circuit portion 253B of FIGS. 2A and 2B.

The energy generation/transmission activation portion 652 may in various implementations include a single actuator (e.g., actuator 255) or may include multiple actuators with different separated circuit portions for the energy generation portion and the transmission activation portion. The power management circuit 654 regulates the operation of the circuitry of the measurement transmission system 650 according to the amount of available energy. In various implementations, the power management circuit 654 may accomplish its functions utilizing various voltage regulation and/or voltage detection circuitry for monitoring the remaining energy. For example, in one specific example implementation, the power management circuit 654 may monitor the amount of energy available from an actuation of the energy generation portion 652, and may dictate that the low power micro controller/memory 656 cease operation once the available energy level falls below a certain threshold. Such functions may prevent the micro controller 656 from continuing to attempt to operate when energy levels are critically low, which may result in errors. In general, the limited energy produced by one cycle of operation of the energy generation portion 652 may dictate a limited amount of time for which the measurement transmission system 650 may remain active to wait for a successful transmission signal back from the remote system 680 (e.g., in one specific example implementation approximately ten seconds or less).

In various implementations, the low power micro controller/memory 656 may operate as the central controller for the measurement transmission system 650. In various implementations, the functions of the low power micro controller/memory 656 may include processing the measurement data from the handheld measuring device 601 (e.g., as connected through a data port or connection lines), formatting the measurement data for transmission, appending any commands or identifiers to the measurement data as appropriate, outputting the measurement data to the low power transmitter/receiver circuit 660 for transmission to the remote system 680, etc. The handheld measuring device data and/or status/control operations 657 may be utilized to facilitate communications between the handheld measuring device 601 and the low power micro controller/memory 656. For example, when a data hold function is required, the handheld measuring device data and/or status/control operations portion 657 may be utilized to determine the proper control signal to be sent to the handheld measuring device processing and control portion 612 for triggering the hold function.

The low power micro controller/memory 656 also interacts with the controller routines portion 658 for performing various operations. The controller routines portion 658 is shown to include actuator operations 671, hold/queue operations 672, transmit operations 674, signal reception operations 676 and identification link operations 678. In various implementations, the actuator operations 671 may be utilized for determining when an actuator has been operated by a user and/or various state dependent operations as described above with respect to FIGS. 1-5. For example, in one example implementation, an actuator may be operated a first time for triggering a hold operation, and then operated a second time for triggering a transmission operation, as may be implemented by the actuator operations 671.

The hold/queue operations 672 may be utilized to implement various data hold functions. For example, the hold/queue operations 672 may be utilized to cause the low power micro controller/memory 656 to store the measurement data internally when a data hold actuator is operated by a user and/or may transmit instructions to the handheld measuring device processing and control portion 612 for storing the measurement data as part of a hold operation that is internal to the handheld device 601. As another example of the hold/queue operations 672, when data holding release operations are to be implemented (e.g., as a result of a successful transmission signal being received from the remote system 680), a signal may be sent by the low power micro controller 656 to the handheld measuring device processing and control portion 612 for terminating the data holding state.

The transmit operations 674 may be utilized for serialization, appending additional information to the measurement data (e.g., device identification, etc.), and/or various formatting or commands for assisting the operation of the measurement data application program 692 of the remote system 680. As one specific example, when the measurement data is being input into a spreadsheet of the measurement data application program 692, the transmit operations 674 may include an “enter” command at the end of the measurement data that is being transmitted. In this manner, the “enter” command may cause the spreadsheet application to move to the next cell after the measurement data is entered, so as to be ready to receive the next transmitted measurement data.

The signal reception operations 676 may be utilized in various implementations for processing signals that are received from the remote system 680 or other systems. For example, as described above, in one implementation the remote system 680 may send a successful transmission signal back to the measurement transmission system 650 once the measurement data has been successfully received by the remote system 680. The signal reception operations 676 may be utilized for decoding or otherwise processing the format of such signals as they may be received from the remote system 680. In addition, in an implementation where the measurement transmission system 650 is required to switch between transmitting and receiving modes, the signal reception operations 676 may assist with the coordination for determining when a transmitting mode and a receiving mode should be active.

The identification link operations 678 may be utilized to include information with the transmitted measurement data that allows the remote system 680 to determine which type of device and/or which of several devices the measurement data is being received from. For example, a remote system 680 may have several handheld measuring devices sending measuring data to it within a given time frame, for which it may be desirable for the remote system 680 to be able to determine which of the handheld measuring devices a current set of measuring data has been received from. In addition, different types of handheld measuring devices may be enabled for sending measuring data (e.g., different types of calipers, gauges, etc.) for which the measuring data may be interpreted or processed differently, for which proper identification of the measuring devices may be needed.

Those skilled in the art will appreciate that the various illustrated circuit portions of the measurement system 600 may generally consist of or be embodied in any types of computing systems or devices. Such computing systems or devices may include one or more processors that execute software to perform the functions described herein. Processors include programmable general-purpose or special-purpose microprocessors, programmable controllers, application-specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical-based disks, flash memory devices, or any other type of non-volatile storage medium for storing data. Software may include one or more program modules that include routines, programs, objects, components, data structures, and so on that perform particular tasks or implement particular abstract data types. In distributed computing environments, the functionality of the program modules may be combined or distributed across multiple computing systems or devices and accessed via service calls, either in a wired or wireless configuration.

While preferred embodiments of the present disclosure have been illustrated and described, numerous variations in the illustrated and described arrangements of features and sequences of operations will be apparent to one skilled in the art based on this disclosure. Various alternative shapes and forms may be used to implement the principles disclosed herein. In addition, the various embodiments described above can be combined to provide further embodiments. All of the U.S. patents and U.S. patent applications referred to in this specification are incorporated herein by reference, in their entirety. Aspects of the embodiments can be modified, if necessary to employ concepts of the various patents and applications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A self-powered measurement transmission system for wirelessly transmitting measurement data from a handheld measuring device to a remote system, the self-powered measurement transmission system comprising:
a device-side data connection portion configured to couple to the handheld measuring device and receive the measurement data from the handheld measuring device;
an output-side wireless transmission portion configured to wirelessly transmit the measurement data to the remote system;
a transmission activation portion comprising a transmission actuator operated manually by a user for triggering the self-powered measurement transmission system to perform operations including a transmission cycle of operations comprising wirelessly transmitting the measurement data to the remote system; and
an energy generation portion comprising an energy generation actuator operated manually by the user, wherein the energy generation portion converts work done on the energy generation actuator by the user into electrical energy that is utilized for powering at least the output-side wireless transmission portion for wirelessly transmitting the measurement data from the output-side wireless transmission portion to the remote system.

2. The self-powered measurement transmission system of claim 1, wherein the transmission cycle of operations consumes a first amount of electrical energy and the energy generation portion is configured such that a single actuation cycle of the energy generation actuator generates a second amount of electrical energy that is greater than the first amount of electrical energy.

3. The self-powered measurement transmission system of claim 1, wherein the self-powered measurement transmission system is housed in a body portion to form a self-powered measurement transmission module which exposes at least the energy generation actuator to the user, and which is configured to couple at least electronically to the handheld measuring device.

4. The self-powered measurement transmission system of claim 3, wherein the self-powered measurement transmission module is configured to couple mechanically and electronically to a coupling feature on the handheld measuring device.

5. The self-powered measurement transmission system of claim 3, wherein the self-powered measurement transmission module is configured to operate without consuming power from the handheld measuring device.

6. The self-powered measurement transmission system of claim 5, wherein the self-powered measurement transmission module does not include a battery.

7. The self-powered measurement transmission system of claim 1, further comprising a data hold actuator operated manually by the user for triggering operations that initiate a data holding state that freezes a set of measurement data to be used for subsequent wireless transmission to the remote system.

8. The self-powered measurement transmission system of claim 7, wherein the handheld measuring device comprises a measurement display and a hold mode of operation which includes freezing a current measurement value on its measurement display, and the operations that initiate a data holding state that freezes a set of measurement data comprise triggering the hold mode of operation of the handheld measuring device through the device-side data connection portion.

9. The self-powered measurement transmission system of claim 7, wherein the operations that initiate a data holding state that freezes a set of measurement data comprise temporarily storing the set of measurement data in a memory of the self-powered measurement transmission system for subsequent wireless transmission to the remote system.

10. The self-powered measurement transmission system of claim 7, wherein the transmission actuator and the energy generation actuator comprise a single actuator that provides both functions.

11. The self-powered measurement transmission system of claim 10, wherein the transmission actuator and the energy generation actuator and the data hold actuator comprise a single actuator that provides all three functions.

12. The self-powered measurement transmission system of claim 11, wherein the self-powered measurement transmission system is configured to provide state-dependent operations which include responding to an actuation of the single actuator when the data holding state is not active by triggering the operations that initiate the data holding state and not triggering a set of operations that includes the transmission cycle of operations, and responding to an actuation of the single actuator when the data holding state is already active by triggering the set of operations that includes the transmission cycle of operations.

13. The self-powered measurement transmission system of claim 7, wherein the transmission cycle of operations further comprises data holding release operations, which are performed subsequently to successfully transmitting the measurement data and which terminate the data holding state.

14. The self-powered measurement transmission system of claim 1, wherein the transmission cycle of operations further comprise transmission cycle termination operations, which are performed subsequently to successfully transmitting the measurement data and which terminate at least some of the operations of the self-powered measurement transmission system until one of the actuators of the self-powered measurement transmission system is again operated manually by the user.

15. The self-powered measurement transmission system of claim 14, wherein the self-powered measurement transmission system comprises a wireless receiver portion, and the transmission cycle termination operations are performed subsequently to receiving a successful transmission signal from the remote system.

16. The self-powered measurement transmission system of claim 1, wherein the self-powered measurement transmission system is housed in the handheld measuring device, which exposes at least the energy generation actuator to the user.

17. The self-powered measurement transmission system of claim 16, wherein the transmission actuator and the energy generation actuator comprise a single actuator that provides both functions.

18. The self-powered measurement transmission system of claim 1, wherein the handheld measuring device is one of a caliper or micrometer, and the measurement data is related to a physical dimension of a measured object.

19. The self-powered measurement transmission system of claim 1, wherein the energy generation actuator comprises one of a button, slide or lever.

20. The self-powered measurement transmission system of claim 19, wherein the energy generation actuator is configured to perform work on one of a piezoelectric element or an electromagnetic generator included in the energy generation portion.

21. A measurement transmission system for wirelessly transmitting measurement data from a handheld measuring device to a remote system, the measurement transmission system comprising:
a device-side data connection portion configured to couple to the handheld measuring device and receive measurement data from the handheld measuring device;
an output-side wireless transmission portion configured to wirelessly transmit measurement data to the remote system;
a transmission activation portion comprising a transmission actuator operated manually by a user for triggering the measurement transmission system to perform operations including a transmission cycle of operations comprising wirelessly transmitting the measurement data to the remote system; and
a data hold actuator operated manually by a user for triggering operations that initiate a data holding state that freezes a set of measurement data to be used for subsequent wireless transmission to the remote system.

22. The measurement transmission system of claim 21, wherein the transmission actuator and the data hold actuator comprise a single actuator that provides both functions.

23. The measurement transmission system of claim 22, wherein the measurement transmission system is housed in the handheld measuring device.

24. The measurement transmission system of claim 22, wherein the measurement transmission system is configured to provide state-dependent operations which include responding to an actuation of the single actuator when the data holding state is not active by triggering the operations that initiate the data holding state and not triggering the set of operations that includes the transmission cycle of operations, and responding to an actuation of the single actuator when the data holding state is already active by triggering the set of operations that includes the transmission cycle of operations.

25. The measurement transmission system of claim 21, wherein the transmission cycle of operations further comprise data holding release operations, which are performed subsequently to successfully transmitting the measurement data and which terminate the data holding state.

26. The measurement transmission system of claim 21, wherein the transmission cycle of operations further comprise transmission cycle termination operations, which are performed subsequently to successfully transmitting the measurement data and which terminate at least some operations of the measurement transmission system until an actuator of the measurement transmission system is again operated manually by a user.

27. The measurement transmission system of claim 26, wherein the measurement transmission system comprises a wireless receiver portion, and the transmission cycle termination operations are performed subsequently to receiving a successful transmission signal from the remote system.

28. The measurement transmission system of claim 21, wherein the measurement transmission system is housed in a body portion to form a measurement transmission module which is configured to couple at least electronically to the handheld measuring device.

29. The measurement transmission system of claim 28, wherein the measurement transmission module is configured to couple mechanically and electronically to a coupling feature on the handheld measuring device.
